(19) United States
(12) Patent Application Publication
(10) Pub. No.: US 2009/0142153 A1
(43) Pub. Date: Jun. 4, 2009

(54) Method and Production Line For Producing Sliding Sleeves

(76) Inventors: Erich Prock, Duesseldorf (DE); Martin Strauch, Wuppertal (DE)

Correspondence Address: ST. ONGE STEWARD JOHNSTON & REENS, LLC, 986 BEDFORD STREET, STAMFORD, CT, 06905-5619, US

(21) Appl. No.: 12/105,072

(22) Filed: Apr. 17, 2008

Related U.S. Application Data
(63) Continuation of application No. PCT/EP2006/067369, filed on Oct. 13, 2006.

(30) Foreign Application Priority Data
Oct. 17, 2005 (DE) 10 2005 049528.1

(51) Int. Cl. B23F 5/00; B23F 19/00

(52) U.S. Cl. 409/12; 409/9

(57) ABSTRACT

The invention relates to a method and to a production line for carrying out the method for producing internal geared workpieces, particularly sliding sleeves. The invention discloses a method, which is advantageous with regard to production engineering, for producing a sliding sleeve and a production line for carrying out the method. With regard to the method, the invention provides that the teeth of the workpiece are made on the finished tooth contour by hob peeling, and the tooth flanks and/or the tooth faces are subsequently machined with a cutting edge tool, and with regard to the production line, the invention provides a shaping device for making teeth having a crude tooth contour, a hob peeling device, which is located downstream from the shaping device and which serves to finish the finished tooth contours of the teeth, and a tooth flank and/or tooth face machining device located downstream from a hob peeling device.

### CROSS-REFERENCE TO RELATED APPLICATIONS

The present application is a continuation of pending International patent application PCT/EP2006/067369 filed on Oct. 13, 2006 which designates the United States and claims priority from German patent application 10 2005 049 528.1 filed on Oct. 17, 2005, the content of which is incorporated herein by reference.

### FIELD OF THE INVENTION

The invention relates to a method and a production line for producing synchroniser sleeves used in automobile gearboxes.

### BACKGROUND OF THE INVENTION

Synchronizer sleeves are often used in automobile gearboxes. They have internal teeth and externally disposed circumferential ribs on which displacing drives engage in order to shift the synchroniser sleeves axially in the gearbox. The internal teeth of the synchroniser sleeves have so-called undercuts which are produced in the machining process. In addition, the tooth faces have roof-like chamfers which are also produced by machining. A conventional method for producing undercuts and chamfers is the fly-cutter milling process, as is described for example in DE 102 00 501 4914. DE 102 00 503 3894 also describes a method of this kind. It is also known from DE 101 13 653 A1 to provide chamfers on an externally toothed gearwheel by means of two single-tooth fly cutters driven in opposite directions. The chamfers on an internally toothed gearwheel, such as synchroniser sleeve, are produced in similar manner.

The production of undercuts is described for example by DE 101 16 259 A1. A multi-toothed milling tool is there described by means of which the undercuts are introduced, dry, into the tooth flanks. It is however also possible to form these by means of a single-toothed fly cutter, the path of travel being usually a cycloid.

The internal teeth of the synchroniser sleeve are, according to the state of the art, produced by broaching. Broaching is a wet machining process. It is also necessary to previously turn to a shape, the blank to be provided with teeth.

### SUMMARY OF THE INVENTION

Accordingly, it is an object of the present invention to provide a method and a production line for producing a synchroniser sleeve which is advantageous in terms of production technology.

In order to overcome the deficiencies of the prior art and to achieve the object of the invention, an embodiment of said method includes using a blank that is machined dry in the hob peeling process. The blank may be one which does not have teeth, but preferably the blank has been preformed with teeth. The teeth of the blank have an oversize of approximately between 0.1 mm and 0.3 mm which is removed in the course of the subsequent hob peeling. Preferably a pressed blank is used. This means that the blank is produced in a dry machining process by pressing only, for example in the course of a rolling process. This may take place on a first machine of a production line. It is however also envisaged to pre-prepare blanks for different modules, the modules being similar to one another. The respective module is then incorporated in the hob peeling process, i.e. in the course of fine machining. In the hob peeling process, the axes of the workpiece spindle and the tool spindle are non-aligned with one another. The axes cross at an angle. The machining process is continuous, during which the hob peeling wheel is also able to work into solid material. Preferably however, a blank preformed with teeth having a coarse tooth shape is used. The method demands particularly stiff machines, for which reason the method according to the invention is carried out on machine tools in which the tool spindle and/or the workpiece spindle are driven by a torque motor. Torque motors are able not only to rotate very slowly but also to apply very high turning moments even at slow speeds of rotation, very small deviations in the path time behavior of the machine being present. A further machining step on a following machine tool of the production line may then follow the hob peeling. This is preferably the forming of the undercuts, pockets or the like already mentioned above, and the formation of the chamfers. It is pertinent that all machining steps, may be effected dry, in particular even the production of the blank. The blanks may be produced in the course of a cold pressing process. The kinematics in the hob peeling are characterized by the work wheel and the peeling wheel having the same direction of rotation. They mesh with one another while having non-aligned axes of rotation, so that they define a “hyperbolic gear mechanism”. On account of this set-up, the cutting edge of the peeling wheel moves in the direction of the tooth gaps of the work wheel during rotation of the peeling wheel and removes a chip. Thus no stroke movement is required. The lost time of a return stroke does not arise. In order to machine the entire width of the work wheel there is superimposed on the rotation of the peeling wheel an axial feed in the direction of the axis of the work wheel.

An embodiment of a production line for producing a synchroniser sleeve is also provided. The production line includes a pressing machine, which is a first machine on the production line, for producing a blank with coarse teeth in a dry machining process. The blank is then passed on to a hob peeling machine, which is located downstream from the pressing machine, for fine machining of the teeth. The production line further includes a machining unit for tooth flanks and/or tooth end faces, which is the last machine on the production line. The machining unit is used for forming of the undercuts, pockets or the like and the formation of the chamfers on the teeth. The hob peeling machine and the machining unit use tool spindles and workpiece spindles that are driven by torque motors, which allow for very high turning moments even at slow speeds of rotation.

### BRIEF DESCRIPTION OF THE DRAWINGS

An embodiment of the invention is explained hereinbelow with reference to accompanying drawings, in which:

FIG. 1 shows, in a highly schematic illustration, engagement of a hob peeling tool in a workpiece 1 which has been pre-formed with oversized teeth.

FIG. 2 shows a block diagram of machining units located one after the other in a production line.

FIG. 3 shows a plan view onto the end of a blank 1 which has been preformed with teeth.

FIG. 4 shows a section on the line IV-IV in FIG. 3 of a finished, machined workpiece with teeth formed on the inside.

### DETAILED DESCRIPTION OF THE INVENTION

The finished tooth shape 6 is produced on a hob peeling machine WS located downstream of the pressing unit U. The finished tooth shape 6 is here dependent on the cross-sectional shape of the cutting teeth of the hob peeling tool 3. In order to change the finished tooth shape 6 in the production line, only the tool 3 requires therefore to be exchanged. In addition, the production parameters of the machine must be altered.

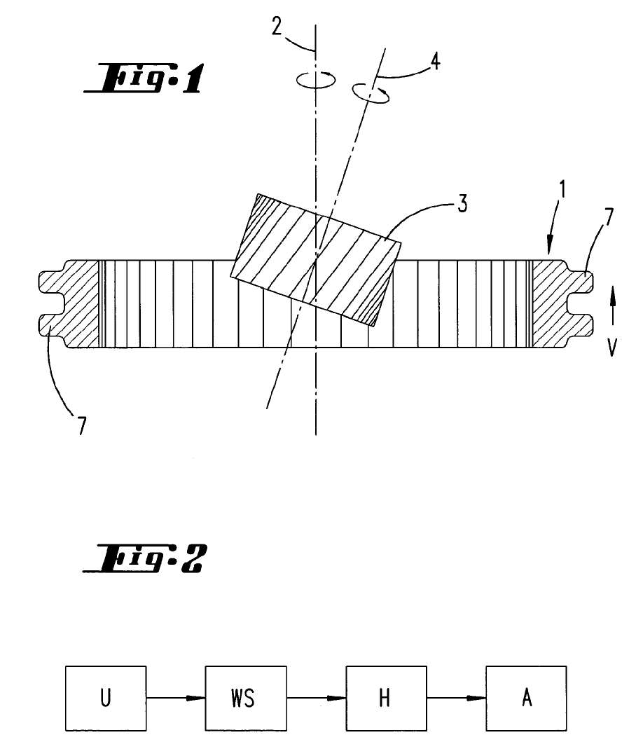

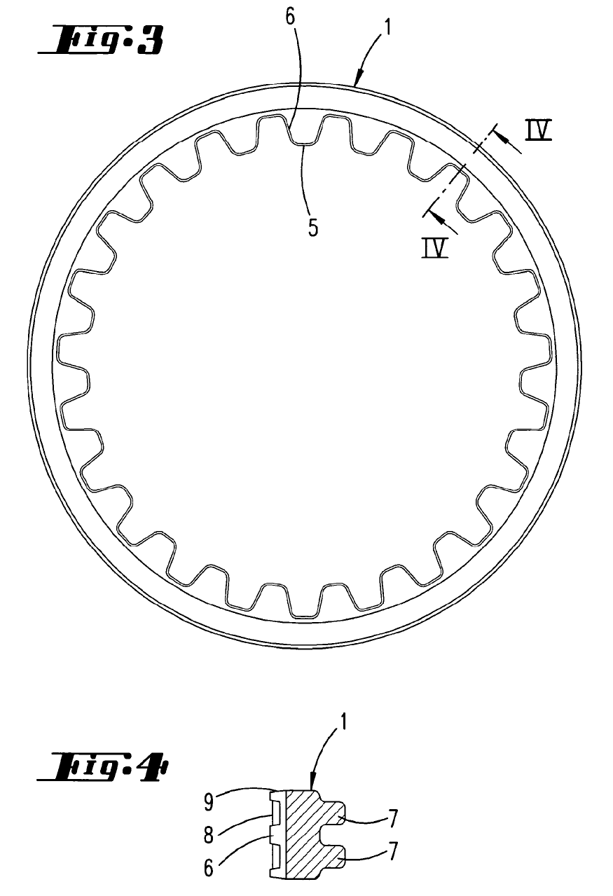

The construction of the hob peeling machine WS used is illustrated in the drawings only very schematically, FIG. 1 showing a workpiece 1 which has teeth on its inside, the teeth having a coarse tooth shape 5. The blank 1 is driven in rotation by a workpiece spindle, not illustrated. It thus rotates about the workpiece axis of rotation 2. The axis of rotation 4 of the hob peeling tool 3 runs out of alignment with the axis of rotation 2 of the workpiece. The tool 3 and workpiece 2 are each driven by individual drive motors which are connected to one another by a so-called electronic shaft. This is effected without gearing. The workpiece 1 and tool 3 are connected directly via a shaft to the electric motors driving them. The drive motors are so-called torque motors. By means of these motors, the workpiece spindle and tool spindle can be continuously driven in rotation in a substantially fixed rotational speed ratio, the cutting edges of the tool 3 which is out of alignment with the workpiece 1 engaging in a peeling manner in the teeth of the workpiece 1. During this peeling machining action, the workpiece 1 is fed forward in the axial direction 2 in the direction of the arrow V. For a high speed of rotation, the action resembles hammering, the teeth, in particular oblique teeth of the tool 3, executing a rolling action within the teeth of the workpiece 1.

The workpiece spindle motor and tool spindle motor are controlled by a synchronization control unit, not illustrated. This synchronization control unit receives angular position information for the workpiece spindle and the tool spindle from a rotary position transducer, not illustrated. Both the workpiece spindle and the tool spindle each have a rotary position transducer, which forwards pulses to the synchronization control unit. From this angular position information, AC and DC drive currents are generated, in order to drive the workpiece spindle motor and the tool spindle motor. Both motors are torque motors. They have a multiplicity of windings associated with the stator or the rotor and distributed at a uniform angular spacing, the windings being respectively supplied with the AC or the DC current and interacting with magnets associated with the stator or the rotor and distributed at a uniform angular spacing, it being possible for these magnets to be permanent magnets. In a torque motor, the number of magnets or the number of windings must be more than at least ten. An exceptional stiffness is achieved in the drive by the number of magnets being different from the number of windings. The number of magnets can be greater or less than the number of windings. In the case of uniform circumferential distribution of the magnets or windings, this has the result that in each case only one to three windings are located opposite a respective magnet. The other windings are disposed at an angular displacement from the magnets associated with them. The number of windings can be greater than 12, 16, 20, 28, 36, 50 or 72. The number of magnets differs from the number of windings by at least 2, 4, 8, 12, 18, 24 or 30.

Downstream of the hob peeling machine there is located at least one unit H, A for machining tooth flanks or tooth end faces. In the exemplary embodiment, the hob peeling machine WS is followed first of all by a unit H for producing undercuts or pockets. The manner of operation of a unit of this kind is described by DE 41 17 365 C1 or DE 42 00 418 C1 or DE 199 33 137 A1 DE, for which reason the content of these documents is incorporated in full into this application. The generation of undercuts is effected for example in a rotational process, in which the workpiece axis and the tool axis are driven continuously in rotation at a fixed rotational speed ratio. The feed is effected by superposition of the phase position change with a variation in the spacing between the two axes of the workpiece spindle and the tool spindle, the axes being arranged parallel to one another. In his way, the undercuts in the teeth flanks, designated in FIG. 4 by reference 8, are machined in.

The unit H for forming the undercuts is followed finally by a chamfering unit A by means of which the end faces of the teeth are machined, as is described in U.S. Pat. No. 4,726,720 and DE 323 40 165. The last-mentioned application is integrated in full into this application. Roof-like surfaces are there produced on the end faces of the teeth by means of two fly cutters driven in rotation in opposite directions. These surfaces are indicated in FIG. 4 by the reference numerals 9.

It is pertinent that all method steps of the units U, WS, H, A are carried out dry. The individual processing machines, U, WS, H, A, are linked with one another by workpiece transport devices, not illustrated, in particular conveyor belts and buffer stores.

In a preferred configuration of the invention, the hob peeling machine WS, the unit H for producing the undercuts and the unit A for the chamfers are formed by one machine, so that transfer time for the workpiece is reduced. The entire process can then be carried out on a pressing machine and on a machining unit. The initial preparation of the workpiece does not necessarily have to be effected by pressing. The coarse tooth shape can also be produced by pre-broaching or by another suitable process.

All features disclosed are (in themselves) pertinent to the invention. The disclosure content of the associated/attached priority documents (copy of the prior application) is hereby also included in full in the disclosure of the application, also for the purpose of incorporating features of these documents in claims of the present application.

1. A method for producing internally toothed work pieces, including synchroniser sleeves, comprising the steps of:
pre-forming a blank workpiece with teeth;
bringing the teeth of the workpiece to a finished tooth shape by hob peeling; and
subsequently machining tooth portions by a cutting edge tool

2. The method according to claim 1, characterized in that the workpiece to be brought to the finished tooth shape by hob peeling pre-formed with teeth by pressing, a coarse tooth shape of the teeth of the blank being produced with an oversize.

3. The method according to claim 1, characterized in that the pre-forming of the teeth is effected by pre-broaching.

4. The method according to claim 2, characterized in that the coarse tooth shapes are effected by a rolling process.

5. The method according to claim 2, characterized in that the oversize of the coarse tooth shape is between approximately 0.1 mm and 0.3 mm.

6. The method according to claim 1, characterized in that the machining of the tooth portions is effected by a fly cutter, in particular a single-tooth fly cutter tool or a multi-tooth fly cutter tool.

7. The method according to claim 1, characterized in that undercuts, pockets, or the like, and/or chamfers are produced on the tooth faces by the cutting edge tool.

8. The method according to claim 1, characterized in that the machining of the tooth portions is effected by a rotational process, whereby the workpiece and the cutting edge tool are driven continuously in rotation and the cutting edge tool finishes the teeth by machining them.

9. The method according to claim 1, characterized in that all processes are carried out dry starting from an annular blank which is substantially without teeth.

10. The method according to claim 1, characterized in that a workpiece spindle and/or a tool spindle of the machine tool which carries out the hob peeling step are driven by torque motors.

11-12. (canceled)

13. A production line for producing internally toothed work pieces, including synchroniser sleeves, comprising:
a pressing machine for producing teeth provided with a coarse tooth shape blank;
a hob peeling machine for producing a finished tooth shape from said blank;
a machining unit for machining tooth portions;
whereby said hob peeling machine is located downstream of said pressing machine; and
whereby said machining unit is located downstream of said hob peeling machine.

14. The production line according to claim 13, characterized in that tool spindles and workpiece spindles of said machining unit and said hob peeling machine are driven by torque motors.
